(19) United States
(12) Patent Application Publication
(10) Pub. No.: US 2012/0199540 A1
(43) Pub. Date: Aug. 9, 2012

(54) FILTER COMPRISING MULTIPLE HALOGENS AND CHITOSAN

(75) Inventors: Sivarooban Theivendran, Reno, NV (US); Terryll Riley Smith, Reno, NV (US); Jeff Snelling, Reno, NV (US); James J. Kubinec, Reno, NV (US)

(73) Assignee: Water Security Corporation, Sparks, NV (US)

(21) Appl. No.: 13/069,029

(22) Filed: Mar. 22, 2011

Related U.S. Application Data
(60) Provisional application No. 61/439,975, filed on Feb. 7, 2011.

(51) Int. Cl. C02F 1/72; B23P 17/04

(52) U.S. Cl. 210/758; 210/198.1; 29/428

(57) ABSTRACT

The water treatment systems may generally comprise multiple halogens and chitosan or derivatives thereof as well as methods of making and using the same. A water treatment system to provide potable water may generally comprise an inlet in fluid communication with an outlet, a halogen release system intermediate the inlet and the outlet, and a halogenated chitosan intermediate the halogen release system and the outlet. The system may comprise a scavenger barrier intermediate the halogenated chitosan and the outlet. The halogen release system may comprise a first halogen having a first oxidizing potential. The halogenated chitosan may comprise a second halogen having a second oxidizing potential. The second oxidizing potential is greater than the first oxidizing potential.

### CROSS REFERENCE TO RELATED APPLICATIONS

This application claims priority to U.S. Provisional Application No. 61/439,975, filed Feb. 7, 2011 the disclosure of which is incorporated by reference herein.

### BACKGROUND

The water treatment systems described herein generally relate to filters comprising multiple halogens and chitosan or derivatives thereof as well as methods of making and using the same.

Over one billion people lack access to reliable and sufficient quantities of safe or potable drinking water. Waterborne contaminants pose a critical health risk to the general public, including vulnerable populations, such as children, the elderly, and those afflicted with disease, if not removed from drinking water. An estimated six million people die each year, half of which are children under 5 years of age, from contaminated drinking water. The U.S. Environmental Protection Agency Science Advisory Board considers contaminated drinking water one of the public's greatest health risks.

Many people rely on groundwater as their only source of water. Groundwater was believed to be relatively pure due to its percolation through the topsoil; however, research has shown that up to 50% of the active groundwater sites in the United States test positive for waterborne contaminants. Waterborne contaminants may include microorganisms, including viruses, such as enteroviruses, rotaviruses and other reoviruses, adenoviruses Norwalk-type agents, other microbes including fungi, bacteria, flagellates, amoebae, Cryptosporidium, Giardia, other protozoa, prions, proteins and nucleic acids, pesticides and other agrochemicals, including organic chemicals, inorganic chemicals, halogenated organic chemicals and other debris. Accordingly, the removal of waterborne contaminants may be necessary to provide potable drinking water for the general public; water for emergency use during natural disasters and terrorist attacks; water for recreational use, such as hiking and camping; and water for environments in which water must be recirculated, such as aircraft and spacecraft.

Therefore, more efficient water treatment systems are desirable.

### BRIEF DESCRIPTION

Various embodiments of the present disclosure relate to water treatment systems to provide potable water.

According to one embodiment, the present disclosure provides a water treatment system comprising multiple halogens to provide potable water. The system initially comprises an inlet in fluid communication with an outlet, a halogen release system comprising a first halogen having a first oxidizing potential, wherein the halogen release system is intermediate the inlet and the outlet; a halogenated chitosan comprising a second halogen having a second oxidizing potential, wherein the halogenated chitosan is intermediate the halogen release system and the outlet and wherein the second oxidizing potential is greater than the first oxidizing potential.

According to a second embodiment, the present disclosure provides a method of treating water comprising at least one contaminant by treating the water with the water treatment system, as described herein. The method comprises flowing the water sequentially through the inlet, the halogen release system, the halogenated chitosan and the outlet to provide potable water, wherein the system has a Log reduction value for viruses of at lease 4 and a Log reduction value for bacteria of at least 6.

In still further embodiments, the present disclosure provides a method of manufacturing a water treatment system initially comprising multiple halogens comprising an inlet in fluid communication with an outlet, a halogen release system intermediate the inlet and the outlet and a halogenated chitosan intermediate the halogen release system and the outlet. The method comprises contacting a halogenating agent and a filter material comprising chitosan or a derivative thereof to generated the halogenated chitosan; positioning the halogen release system intermediate the inlet and the outlet; and positioning the halogenated chitosan intermediate the halogen release system and the outlet.

### DESCRIPTION OF THE DRAWINGS

The various embodiments described herein may be better understood by considering the following description in conjunction with the accompanying drawings.

FIGS. 1A-C include illustrations of various embodiments of water treatment systems as described herein.

FIGS. 2 and 3 include charts illustrating various embodiments of a method described herein.

FIGS. 4 and 5 include charts illustrating iodine and iodide elution according to an embodiment of a water treatment system as described herein.

FIGS. 6 and 7 include charts illustrating iodine and iodide elution according to an embodiment of a water treatment system as described herein.

FIGS. 8 and 9 include charts illustrating iodine and iodide elution according to an embodiment of a water treatment system as described herein.

FIG. 10 includes a chart illustrating iodine and iodide elution according to an embodiment of a water treatment system as described herein.

### DESCRIPTION OF CERTAIN EMBODIMENTS

As generally used herein, the terms “include” and “have” mean “comprising”.

As generally used herein, the term “about” refers to an acceptable degree of error for the quantity measured, given the nature or precision of the measurements. Typical exemplary degrees of error may be within 20%, 10%, or 5% of a given value or range of values. Alternatively, and particularly in biological systems, the term “about” may mean values that are within an order of magnitude, potentially within 5-fold or 2-fold of a given value.

All numerical quantities stated herein are approximate unless stated otherwise, meaning that the term “about” may be inferred when not expressly stated. The numerical quantities disclosed herein are to be understood as not being strictly limited to the exact numerical values recited. Instead, unless stated otherwise, each numerical value is intended to mean both the recited value and a functionally equivalent range surrounding that value. At the very least, and not as an attempt to limit the application of the doctrine of equivalents to the scope of the claims, each numerical parameter should at least be construed in light of the number of reported significant digits and by applying ordinary rounding techniques. Notwithstanding the approximations of numerical quantities stated herein, the numerical quantities described in specific examples of actual measured values are reported as precisely as possible.

All numerical ranges stated herein include all sub-ranges subsumed therein. For example, a range of “1 to 10” is intended to include all sub-ranges between and including the recited minimum value of 1 and the recited maximum value of 10. Any maximum numerical limitation recited herein is intended to include all lower numerical limitations. Any minimum numerical limitation recited herein is intended to include all higher numerical limitations.

As generally used herein, the phrases “Log Removal” and “Log reduction value” refer to the Logᵢ( )of the ratio of the level of contaminants (typically the number of microorganisms) in the influent to the level of contaminants (typically the number of microorganisms) in the effluent.

As generally used herein, “to reduce contaminants” and “reducing contaminants” refer to disarming one or more contaminants in the fluid, whether by physically or chemically killing, removing, reducing, or inactivating the contaminants or otherwise rendering the one or more contaminants harmless.

In the following description, certain details are set forth to provide a thorough understanding of various embodiments of the apparatuses and/or methods described herein. However, a person having ordinary skill in the art will understand that the various embodiments described herein may be practiced without these details. In other instances, well-known structures and methods associated with the apparatuses and/or methods described herein may not be shown or described in detail to avoid unnecessarily obscuring descriptions of the embodiments described herein.

This disclosure describes various features, aspects, and advantages of various embodiments of water treatment systems as well as methods of making and using the same. It is understood, however, that this disclosure embraces numerous alternative embodiments that may be accomplished by combining any of the various features, aspects, and advantages of the various embodiments described herein in any combination or sub-combination that one of ordinary skill in the art may find useful.

A conventional water treatment system or filter having an iodine release system, chitosan, and an iodine scavenger barrier may suffer from iodine shortage and/or iodide leakage. Iodine shortage generally refers to the reduction of iodine in the water treatment system after extended use. Iodide leakage generally refers to iodide in the effluent of the water treatment system. Without wishing to be bound to any particular theory, it is believed that organic residuals associated with the chitosan and/or water may reduce iodine to iodide. The Log Removal of conventional filters may lower due to the lower amount of iodine available to reduce contaminants. The higher amount of iodide may saturate the iodine scavenger barrier and leak from conventional filters. In various embodiments, a water treatment system as described herein may be characterized by a higher Log reduction value relative to a corresponding water treatment system lacking multiple halogens and chitosan. In various embodiments, a water treatment system as described herein may be characterized by reduced or no iodine shortage and/or iodide leakage relative to a corresponding water treatment system lacking multiple halogens and chitosan.

According to certain embodiments, a water treatment system comprising multiple halogens and chitosan or derivatives thereof may generally comprise a filter comprising at least one halogen release system and a halogenated chitosan. In various embodiments, the water treatment system may comprise a filter comprising at least one halogen release system, a halogenated chitosan, and at least one scavenger barrier. In various embodiments, the water treatment system may comprise a point-of-use water treatment system comprising a halogen release system, a halogenated chitosan, a halogen scavenger barrier, and/or granular activated carbon. In various embodiments, the point-of-use water treatment system may comprise a self-contained unit that may be used to treat water from untreated sources and/or a self-contained unit, such as a countertop, refrigerator or other unit, which may be used to treat tap water. Certain embodiments may specifically exclude municipal sewage and/or industrial wastewaters and runoff.

In certain embodiments, the filter may comprise a halogen release system. In various embodiments, the halogen release system may comprise one or more of halogenated resins, liquid halogens, gaseous halogens, halogen crystals, halogen compounds, and combinations thereof. In various embodiments, the halogen release system may generally comprise one or more of chlorinated resins, iodinated resins, brominated resins, chlorine, bromine, iodine, iodine crystals, chlorine tablets, trichloroisocyanuric acid (“TCCA”), chlorine dioxide, sodium hypochlorite, solid calcium hypochlorite, sodium chlorite, sodium dichloroisocyanurate, and tetraglycine hydroperiodide.

In certain embodiments, the halogen release system may comprise a halogenated resin. The halogenated resin may be selected from the group consisting of chlorinated resins, brominated resins, iodinated resins, and combinations thereof. In various embodiments, the halogenated resin may comprise a chlorinated resin. In various embodiments, the halogenated resin may comprise an iodinated resin. For example, in various embodiments, the iodinated resin may comprise a Microbial Check Valve or MCV® Resin available from Water Security Corp., Sparks, Nev. The MCV® Resin may achieve a residual iodine ranging between 0.5-4.0 mg/L. The MCV® Resin may achieve a Log reduction value for bacteria and a Log reduction value ≧4 for viruses in contaminated water. In various embodiments, the halogenated resin may comprise a chlorinated resin and an iodinated resin. Halogenated resins are generally described in U.S. Patent Application Pub. No. US 2008/0011662 to Milosavljevic et al.

In certain embodiments, the filter may comprise a filter material selected from the group consisting of chitin, chitin derivatives, chitosan, chitosan derivatives, and any combination thereof. Chitin is a polymer of β-1,4-(2-deoxy-2-acetamidoglucose) that may be extracted from the exoskeletons of insects and arthropods, such as crabs, lobsters and shrimps, and cell walls of fungi and yeast. Chitosan is a derivative of chitin. Chitosan is a polymer comprising 2-deoxy-2-acetamidoglucose monomers and 2-deoxy-2-aminoglucose monomers. Chitosan may be formed from chitin by hydrolyzing at least a portion of the 2-deoxy-2-acetamidoglucose monomeric units to 2-deoxy-2-aminoglucose monomeric units. Chitosan may be fully or partially deacetylated chitin. Chitosan comprises a polymer backbone comprising hydroxyl groups and amine groups. Chitosan may be soluble in aqueous acidic (pH<6.0) solutions.

In certain embodiments, the filter material may comprise chitosan or derivatives thereof. The chitosan or derivatives thereof may have a molecular weight in the range of from 5,000 Daltons to two million Daltons, such as from 50,000 Daltons to one million Daltons, or such as from 100,000 Daltons to 900,000 Daltons. In various embodiments, the chitosan or derivatives thereof may have a molecular weight from 100,000 Daltons to one million Daltons. The chitosan may have a percentage of deacetylation from 40% to 100%, such as from 60% to 95%, or such as from 70% to 90%. In various embodiments, the chitosan or derivatives thereof may have a percentage deacetylation of at least 75%. In various embodiments, the chitosan or derivatives thereof may have a percentage deacetylation of at least 85%. In various embodiments, the chitosan or derivative thereof may have a percentage deacetylation of at least 90%. In various embodiments, the chitosan or derivative thereof may have a percentage deacetylation from 90% to 95%. In various embodiments, the chitosan may have a molecular weight in the range of from 100,000 Daltons to one million Daltons and a percentage of deacetylation from 90% to ≧95%. In certain embodiments, the chitosan or derivative thereof may comprise a powder having a U.S. standard mesh size from 30 mesh to 230 mesh. In certain embodiments, the chitosan or derivative thereof may comprise a nanoparticle having a size from 10 nanometers to 100 nanometers. In certain embodiments, the chitosan or derivative thereof may have a bulk density from 0.1 g/cm³ to 0.5 g/cm³, such as, for example, 0.15 g/cm³ to 0.3 g/cm³. In certain embodiments, the filter material may be selected from the group consisting of a liquid and a solid (e.g., a powder, flake, gel, and/or paste).

In certain embodiments, the filter material may comprise chitosan derivatives. Chitosan derivatives may be prepared by modifying the polymer backbone, such as the hydroxyl groups and amine groups. The two hydroxyl groups may have different reactivity but may be functionalized by hydroxy active agents at high pH on either the acetylated monomers or deacetylated monomers. The amine groups of the deacetylated monomeric unit may be available for reaction where a significant number of the amines are deprotonated. These chemistries may provide chitosan compounds bearing different properties from the original chitosan polymer. The inhibitory activity of chitosan may be higher at pH 6.0 (pKa value of chitosan=6.2) than at pH 7.5, when most of the amino groups are in the free base form.

In certain embodiments, the filter material may comprise a halogenated chitosan. The halogenated chitosan may comprise a chitosan-halogen complex. The halogen may be encapsulated in the lattice matrix of the chitosan or derivative thereof. The chitosan-halogen complex may be selected from the group consisting of a chitosan-chlorine complex, chitosan-bromine complex, chitosan-iodine complex, and any combination thereof. Without wishing to be bound to any particular theory, it is believed that halogen in the chitosan-halogen complex may be readily available in its free or elemental form. The chitosan-halogen complex may comprise an association of the halogen and chitosan or derivatives thereof. The chitosan-halogen complex may generally comprise a reversible association of molecules, atoms, or ions through weak chemical bonds.

In various embodiments, the chitosan-halogen complex may comprise one or more of a chlorinated chitosan and an iodinated chitosan. In various embodiments, the chitosan-halogen complex may comprise a chlorinated chitosan. The chitosan-chlorine complex may include chlorine and chloride complexed to the chitosan or derivative thereof. The chlorine molecules in the chitosan-halogen complex may be readily available as a free chlorine form. In various embodiments, the chitosan-halogen complex may comprise an iodinated chitosan. The chitosan-iodine complex may include iodine and/or iodide complexed to the chitosan or derivative thereof. Suitable iodides include, but are not limited to, iodine-iodide complexes of the form (cation)⁺(I₃)⁻, wherein the cation is a cationic small molecule, such as a metal ion, e.g., potassium or sodium ions, or a cationic group attached to the chitosan. Examples of chitosan-iodine complexes are generally described in U.S. Pat. No. 4,275,194 to Kato et al., U.S. Pat. No. 5,204,452 to Dingilian, et al., U.S. Pat. No. 5,362,717 to Dingilian, et al., U.S. Pat. No. 5,336,415 to Deans, U.S. Pat. No. 5,538,955 to Rosa et al., and U.S. Pat. No. 6,521,243 to Hassan.

In certain embodiments, the halogenated chitosan may comprise up to 50% of bound halogen by weight of the chitosan. In various embodiments, the halogenated chitosan may comprise up to 60-70% of bound halogen by weight of the chitosan. In certain embodiments, the concentration of the halogen may be the range of at least 0.05% by weight, at least 0.5% by weight, 0-5% by weight, and at least 1-5% by weight. Higher concentrations may be used when the halogen is stable against aggregation and evaporation during its shelf life.

According to certain embodiments, the halogenated chitosan may comprise a pristine halogenated chitosan. A water treatment system before any water flows through the inlet may be generally referred to as a “pristine” water treatment system. That is, the water treatment system may initially comprise a halogenated chitosan. Accordingly, any halogen release system, filter material, including halogenated chitosan, and scavenger barrier before any water flows therethrough may be referred to as “pristine” or “initial”. In various embodiments, the halogenated chitosan may comprise a pristine chlorinated chitosan. In various embodiments, the halogenated chitosan may comprise a pristine iodinated chitosan. In various embodiments, the halogenated chitosan may comprise a pristine chlorinated chitosan and a pristine iodinated chitosan. In various embodiments, the halogenated chitosan may comprise a pristine chlorinated chitosan at least one of free, substantially free, and completely free from chloride, iodine, and/or iodide.

In various embodiments, the halogenated chitosan may reduce and/or eliminate any organic residuals in the chitosan and/or saturate the chitosan with halogens to improve the Log reduction value of the water treatment system relative to a corresponding water treatment system lacking the halogenated chitosan. In various embodiments, the halogenated chitosan may oxidize any halogens flowing therethrough having a lower oxidizing potential. According to certain embodiments, the halogenated chitosan may reduce and/or eliminate iodide leakage.

According to certain embodiments, the halogenated chitosan may reduce iodide shortage. According to certain embodiments, the halogenated chitosan may increase the availability of iodine by oxidizing iodide to iodine.

In various embodiments, the filter material may comprise a mixture of chitosan or derivatives thereof and a halogenating agent. The mixture may be a homogenous composition or a heterogeneous composition. The halogenating agent may comprise any agent comprising a halogen, such as chlorine, bromine, and iodine, capable of donating a halogen atom. The halogenating agent may be at least one of chlorine, bromine, iodine, aqueous chlorine solutions, aqueous bromine solutions, aqueous iodine solutions, chlorine dioxide, sodium hypochlorite, calcium hypochlorite, sodium chlorite, sodium dichloroisocyanurate, trichloroisocyanuric acid (“TCCA”), N-chlorosuccinimide, sodium hypobromite, pyridinium bromide perbromide, N-bromosuccinimide, and chloramine-T, and tetraglycine hydroperiodide. In various embodiments, the halogenating agent may comprise a chlorinating agent, such as TCCA, to release chlorine when contacted with water. Other suitable halogenating agents will be readily apparent to those skilled in the art.

In certain embodiments, a method for generating the halogenated chitosan may generally comprise contacting the chitosan or derivative thereof and a halogenating agent. In various embodiments, the halogenating agent may comprise a chlorinating agent, a brominating agent, an iodinating agents and any combination thereof. As a result of the reaction of the chitosan and the halogenating agent, at least a portion of the 2-deoxy-2-aminoglucose monomeric units may be converted to 2-monohalo aminoglucose monomeric units and/or 2,2-dihalo aminoglucose monomeric units to yield the halogenated chitosan. Without wishing to be bound to any particular theory, the halogenating agent may remove any organic residuals from the chitosan and/or saturate the chitosan with halogens to generate the halogenated chitosan.

In certain embodiments, a method for generating the halogenated chitosan may generally comprise contacting the chitosan or derivatives thereof and the halogenating agent prior to positioning the chitosan or derivatives thereof in the water treatment system. In various embodiments, the halogenating agent may comprise a mixture of halogens in an aqueous solvent (e.g., water) and/or non-aqueous solvent (e.g., haloakanes, aliphatic and aromatic alcohols, aliphatic or aromatic ethers and ketones). The halogenated chitosan may be formed by contacting the chitosan or derivatives thereof and an aqueous halogen solution for a period of time from 1 minute to 72 hours, at a pH from 6-8, and a temperature from 23-25° C. In various embodiments, the halogenated chitosan may be formed instantaneously by contacting the chitosan or derivatives thereof and an aqueous halogen solution. In various embodiments, the halogenated chitosan may be formed by mixing the chitosan or derivatives thereof and an aqueous halogen solution for 24 hours, at a pH from 6-8, and a temperature from 23-25° C. In various embodiments, the ratio of halogenating agent to chitosan or derivatives thereof may be from 1:1 to 1:10, such as, for example, 1:2, 1:3, and 1:5. In at least one embodiment, the ratio of halogenating agent to chitosan or derivatives thereof may be from 1:3.33. In various embodiments, the halogenating agent may comprise an aqueous solution of 23.1% w/w halogenating agent. In various embodiments, the halogenating agent may comprise an aqueous solution of 33.3% w/w halogenating agent.

In various embodiments, for example, the aqueous halogen solution may comprise TCCA at least partially dissolved in water. In various embodiments, the ratio of TCCA to chitosan or derivatives thereof may be from 1:1 to 1:10, such as, for example, 1:2, 1:3, and 1:5. In at least one embodiment, the ratio of TCCA to chitosan or derivatives thereof may be from 1:3.33. In various embodiments, aqueous halogen solution may comprise, by weight, 10 parts chitosan to 1 part TCCA, such as 5 parts chitosan to 1 part TCCA, 3 parts chitosan and 1 part TCCA, 2 parts chitosan to 1 part TCCA, and 1 part chitosan to 1 part TCCA. In various embodiments, the halogenating agent may comprise a 23.1% w/w aqueous TCCA solution. For example, in various embodiments, the halogenating agent may comprise, by weight, 3.33 parts chitosan and 1 part TCCA. For example, in various embodiments, the halogenating agent may comprise a 33.3% w/w aqueous TCCA solution. In various embodiments, the halogenating agent may comprise, by weight, 2 parts chitosan and 1 part TCCA. In various embodiments, for example, the halogenating agent may comprise an aqueous halogen solution of iodine crystals at least partially dissolved in water.

In certain embodiments, the halogenated chitosan may be formed in situ by contacting the halogenating agent and chitosan or derivative thereof when the chitosan or derivatives thereof is positioned in the water treatment system. In various embodiments, the halogenating agent may be positioned upstream of the chitosan or derivative thereof, and a fluid, such as water, may be flowed therethrough to generate the halogenated chitosan. In various embodiments, the halogenating agent may comprise a mixture of the halogenating agent and water. In various embodiments, the chlorinated chitosan may be formed in situ by contacting the chitosan or derivative thereof and an aqueous solution of TCCA in water. In various embodiments, the chlorinated chitosan may be formed in situ by contacting the water flowing through the inlet and solid TCCA particles intermediate the inlet and the chitosan. In various embodiments, the iodinated chitosan may be formed in situ by contacting the chitosan or derivative thereof and an aqueous solution of iodine crystals. In various embodiments, the iodinated chitosan may be formed in situ by contacting the chitosan or derivative thereof and the water flowing through the iodine release system. In certain embodiments, the in situ formation of the halogenated chitosan may be performed prior to the use of the water treatment system to provide potable water.

In various embodiments, the water treatment system may comprise at least one scavenger barrier to adsorb or absorb halogens, and/or react with or provide catalytic reaction sites for halogens to convert the halogens to an ionic form. In certain embodiment, the scavenger barrier may be selected from the group consisting of carbon, such as activated carbon, and an ion exchange resin, such as a strong-base anion exchange resin. Activated carbon may comprise any suitable form, such as, for example, carbon pellets, carbon powder, and granular carbon. In various embodiments, the scavenger barrier may comprise granular activated carbon (“GAC”). In various embodiments, the scavenger barrier may comprise a halogen scavenger barrier, such as, for example, an iodine scavenger resin, a chlorine scavenger resin, and a bromine scavenger resin. In various embodiments, the scavenger barrier may comprise strong-base anion exchange resins, such as, for example, Iodosorb®, available from Water Security Corporation, Sparks, Nev., as described in U.S. Pat. No. 5,624,567. Briefly, Iodosorb®, sometimes referred to as an iodine scavenger resin, comprises trialkyl amine groups each comprising alkyl groups containing 3 to 8 carbon atoms which is capable of removing halogens, including iodine or iodide, from aqueous solutions. In various embodiments, the scavenger barrier may comprise a halogen scavenger barrier and GAC, wherein the GAC is intermediate the halogen scavenger barrier and the outlet.

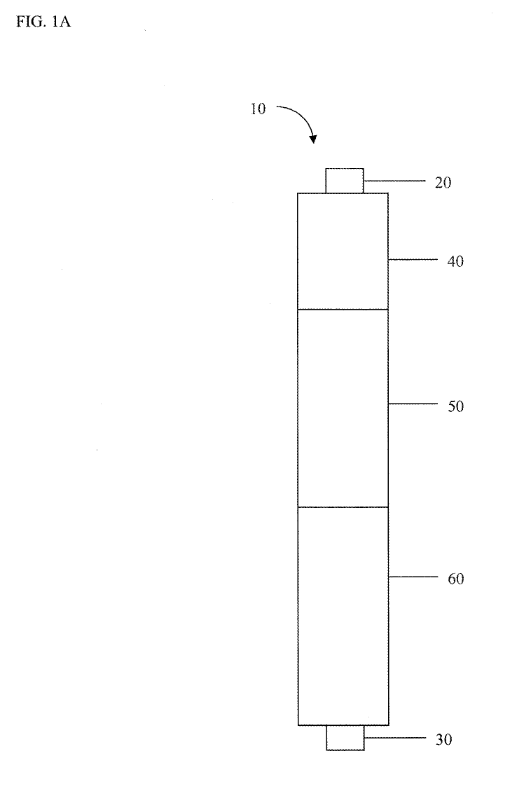

Referring to FIGS. 1A-B, in various embodiments, a water treatment system to provide potable water comprising a filter 10 may generally comprise an inlet 20 in fluid communication with an outlet 30, a halogen release system 40 intermediate the inlet 20 and the outlet 30, a halogenated chitosan 50 intermediate the halogen release system 40 and the outlet 30; and, optionally, a scavenger barrier 60 intermediate the halogenated chitosan 50 and the outlet 30. Referring to FIG. 1 C, in certain embodiments, the water treatment system comprising a filter 10 may generally consist of an inlet 20 in fluid communication with an outlet 30, and a halogenated chitosan 50 intermediate the inlet 20 and the outlet 30. In various embodiments, the halogen release system 40 may comprise an iodinated resin, such as an MCV® Resin, the halogenated chitosan 50 may comprise chlorinated chitosan and/or iodinated chitosan, and the scavenger barrier 60 may comprise an ion exchange resin, such as Iodosorb®, and/or GAC.

In certain embodiments, the volume of the halogen release system may be less than or equal to the volume of at least one of the halogenated chitosan and/or scavenger barrier. In various embodiments, the ratio of the halogen release system to the halogenated chitosan, by volume, may be from 1:1 to 1:1000. In various embodiments, the ratio of the halogen release system to the halogenated chitosan, by volume, may be from 1:18 to 1:36. In various embodiments, the ratio of the halogen release system to the halogenated chitosan, by volume, may be 1:36. In various embodiments, the ratio of the halogen release system to the halogenated chitosan, by volume, may be from 1:1 to 1:1000, and a ratio of the halogen release system to the scavenger barrier, by volume, may be from 1:1 to 1:10. In various embodiments, the ratio of the halogen release system to the halogenated chitosan, by volume, may be from 1:18 to 1:36, and a ratio of the halogen release system to the scavenger barrier, by volume, may be 1:5. In various embodiments, the volume of the iodinated resin may be 22 cc, the volume of the halogenated chitosan may be 60 cc and the volume of the ion exchange resin may by 60 cc.

In certain embodiments, the water treatment system may comprise a housing (not shown). The housing may comprise a longitudinal axis along the z-axis wherein at least one of the inlet, outlet, halogen release system, halogenated chitosan, and scavenger barrier, may be axially aligned along the longitudinal axis. The direction of fluid flow may be from the inlet towards the outlet along the longitudinal axis. The housing may comprise any suitable material, such as, for example, but not limited to, glass, metal, ceramic, plastic, and any combination thereof. In at least one embodiment, the housing material may not be permeable to aqueous and/or non-aqueous liquids. The housing may comprise any suitable shape, such as, for example, but not limited to, a polyhedron, a non-polyhedron, and any combination thereof. In at least one embodiment, the housing may comprise a generally cylindrical shape.

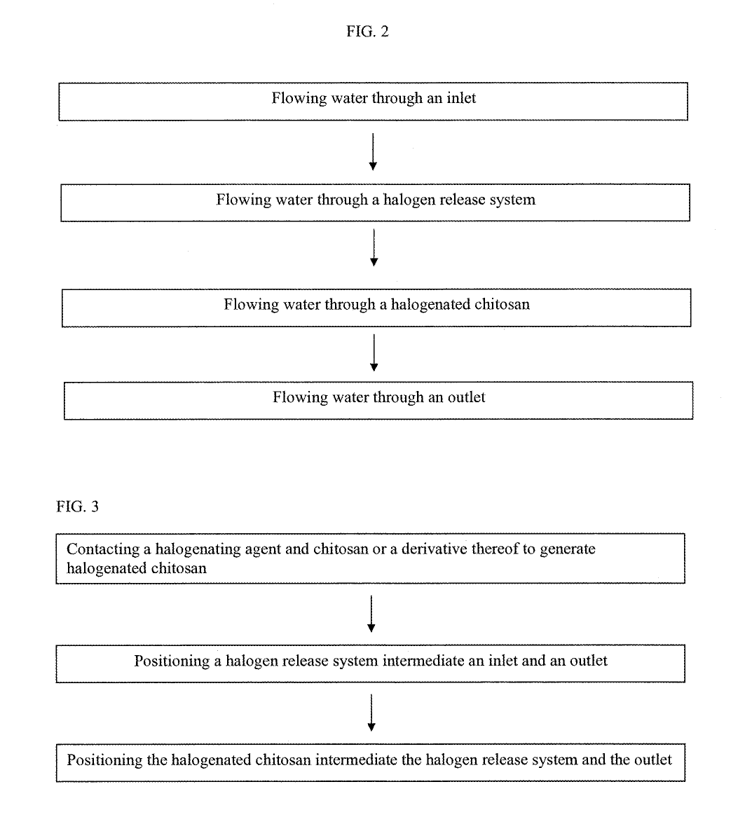

Referring to FIG. 3, according to certain embodiments, a method of manufacturing a water treatment system initially comprising multiple halogens comprising an inlet in fluid communication with an outlet, a halogen release system intermediate the inlet and the outlet, and a halogenated chitosan intermediate the halogen release system and the outlet may generally comprise contacting a halogenating agent, including any of the halogenating agents described herein, and a filter material comprising chitosan or a derivative thereof to generate the halogenated chitosan, positioning the halogen release system intermediate the inlet and the outlet, and positioning the halogenated chitosan intermediate the halogen release system and the outlet. In various embodiments, the water treatment system may comprise at least one scavenger barrier, and positioning the at least one scavenger barrier intermediate the halogenated chitosan and the outlet. In various embodiments, the water treatment system may comprise an ion exchange resin and GAC, and positioning the ion exchange resin intermediate the halogenated chitosan and the outlet, and positioning the GAC intermediate the ion exchange resin and the outlet.

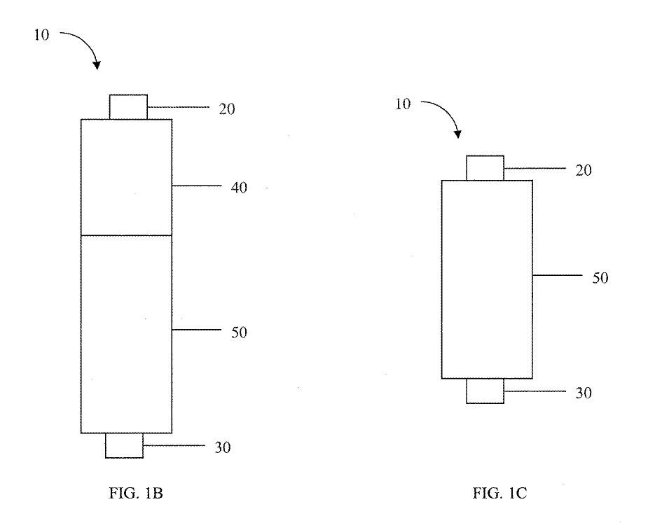

Referring to FIG. 2, in certain embodiments, a method of treating water comprising at least one contaminant by a water treatment system comprising an inlet in fluid communication with an outlet, a halogen release system comprising a first halogen having a first oxidizing potential, wherein the halogen release system is intermediate the inlet and the outlet, a halogenated chitosan comprising a second halogen having a second oxidizing potential, wherein the halogenated chitosan is intermediate the halogen release system and the outlet, and, optionally, a scavenger barrier intermediate the halogenated chitosan and the outlet, the method may generally comprise flowing the water sequentially through the inlet, halogen release system, the halogenated chitosan, the optional scavenger barrier, and outlet. The halogen release system may be any of the halogen release systems described herein, including an MCV® Resin. The halogenated chitosan may be any of the materials described herein, including chlorinated chitosan. The scavenger barrier may be any of the scavenger barriers described herein, including Iodosorb®, and/or GAC.

An influent comprising at least one contaminant may be introduced to the filter via the inlet. The influent may contact the halogen release system. The halogen release system may release halogens into the fluid passing therethrough. The influent may oxidize the first halogen to a first halogen ion. The fluid may flow from the halogen release system to the halogenated chitosan. The halogenated chitosan may absorb and/or adsorb halogens from fluid passing therethrough. The halogenated chitosan may oxidize any halogens flowing therethrough having a lower oxidizing potential. The halogenated chitosan may oxidize the first halogen ion to regenerate the first halogen, and the second halogen may be reduced to a second halogen ion. The halogenated chitosan may oxidize 100%, at least 99%, at least 90% and at least 75% of the first halogen. The halogenated chitosan may release halogens into the fluid passing therethrough. The halogenated chitosan may reduce or remove contaminants in the fluid passing therethrough. The fluid may flow from the halogenated chitosan to the scavenger barrier. The fluid may comprise the first halogen and the second halogen ion. The scavenger barrier may reduce and/or remove contaminants and/or halogens in the fluid passing therethrough. The fluid may flow from the scavenger barrier to the outlet.

For example, in various embodiments, the halogen release system may comprise an iodinated resin, the halogenated chitosan may comprise chlorinated chitosan, and the scavenger barrier may comprise an ion exchange resin and/or GAC. Water comprising contaminants and/or organic residuals may be introduced to the filter via the inlet. The influent may contact the iodinated resin, which may release iodine into the fluid passing therethrough. Without wishing to be bound to any particular theory, it is believed that the chlorinated chitosan and/or contaminants and organic residuals may oxidize the iodine to iodide. The fluid may flow from the iodinated resin to the chlorinated chitosan. The chlorine may oxidize the iodide to iodine, and the chlorine may be reduced to chloride. The chlorine may remain in the chlorinated chitosan. The fluid comprising chloride, iodide, and/or iodine may flow to the ion exchange resin and/or GAC. The chloride, iodide, and iodine may be captured by the ion exchange resin and/or GAC. In various embodiments, the effluent from a water treatment system may comprise chloride and be at least one of free, substantially, and completely free from iodine, iodide, and/or chlorine. In various embodiments, the effluent from a water treatment system may be at least one of free, substantially, and completely free from iodine, iodide, chloride, and/or chlorine. As used herein, the term “substantially free” means that the material is present, if at all, as an incidental impurity. As used herein, the term “completely free” means that the material is not present at all.

According to certain embodiments, the water treatment system may be characterized by an improved Log reduction value from the synergistic effect of the dual halogen activity. The water treatment system may release higher amounts of the first halogen in the effluent to improve the Log reduction value relative to a similar water treatment system lacking the halogenated chitosan. For example, a dual halogen water treatment system comprising an iodinated resin and a chlorinated chitosan may have a synergistic effect to improve the removal of contaminants during initial use and after an extended period of time.

In certain embodiments, the halogenated chitosan may have an empty bed contact time (“EBCT”) of greater than 1 second. The EBCT is the volume of the halogenated chitosan divided by the flow rate. In at least one embodiment, the EBCT may be between 1 second and 120 seconds, such as between 15 seconds and 60 seconds and between 30 seconds and 60 seconds. In certain embodiments, the EBCT of the chitosan or derivative thereof is 30 seconds to 120 seconds. In at least one embodiment, the EBCT of the chitosan or derivative thereof is 120 seconds.

In certain embodiments, the fluid contacting the halogenated chitosan may have a fluid velocity less than 0.5 cm/s. In at least one embodiment, the fluid velocity may be between 0.3 cm/s and 0.5 cm/s. In at least one embodiment, the fluid velocity may be less than 0.3 cm/s. In at least one embodiment, the fluid velocity may be between 0.15 cm/s and 0.24 cm/s. In at least one embodiment, the fluid velocity may be less than 0.15 cm/s. In at least one embodiment, the fluid velocity may be greater than 0.5 cm/s.

### EXAMPLES

The various embodiments described herein may be better understood when read in conjunction with the following representative examples. The following examples are included for purposes of illustration and not limitation. As generally used herein, the terms “ND” refers to not detectable or below the detection limit and “NA” refers to not applicable

The analytical grade chitosan was obtained from Sigma Aldrich, St. Louis, Mo., (product number C3646) having the following properties: biological source: shrimp shells, ≧75% deacetylated, form: powder or flake, and a bulk density 0.15-0.3 g/cm³. The industrial grade chitosan was obtained from Marnard Biotech, Quebec, Canada, having the trade designation Marine Biopolymer LV1. The TCCA was obtained from Acros Organics, Fair Lawn, N.J., having 99% trichloroisocyanuric acid, a molecular weight of 232.41 g, and a solubility in water of 12 g/L.

### Example 1

2.2 g iodine crystals and 750 mL distilled water were added to a 1 L glass bottle. The mixture was stirred on a stir plate with a magnetic stir bar at ambient temperature for 24 hr. The mixture was filtered to remove any undissolved iodine crystals. The iodinated filtrate comprised 294 ppm iodine and no detectable iodide.

### Example 2

The iodine demand of chitosan was evaluated by contacting chitosan and three sequential treatments of iodinated filtrates according to Example 1. Each iodinated filtrate was evaluated for iodine and iodide before and after contacting chitosan. The iodine was measured by the leuco-crystal violet method 4500-I B and the iodide was measured by the leuco-crystal violet method 4500-I⁻ B as described in “Standard Methods for the Examination of Water and Wastewater”, American Water Works Association, 21^{st} edition (2005), pp. 4-95 and 4-98. Table 1 shows the means of three independent measurements of iodine and iodide.

For the first treatment, 750 mL of an iodinated filtrate according to Example 1 and 22 g analytical grade chitosan were added to a 1 L glass bottle. The mixture was tumbled on Wheaton bench top roller at ambient temperature for 24 hr to generate iodinated analytical grade chitosan. The mixture was filtered to separate the iodinated filtrate and the iodinated analytical grade chitosan. The separated iodinated filtrate was evaluated for iodine and iodide. As shown in Table 1, the separated iodinated filtrate had a final iodine concentration of 139 ppm and no detectable iodide. The iodinated analytical grade chitosan was washed with 1 L of distilled water three times to remove any residual iodine and/or iodide.

For the second treatment, 750 mL an iodinated filtrate according to Example 1 and the iodinated analytical grade chitosan from the first treatment were added to a 1 L glass bottle. The mixture was tumbled on Wheaton bench top roller at ambient temperature for 24 hr. The mixture was filtered to separate the iodinated filtrate and the iodinated analytical grade chitosan. The separated iodinated filtrate was evaluated for iodine and iodide. As shown in Table 1, the separated iodinated filtrate had a final iodine concentration of 91 ppm and no detectable iodide. The iodinated analytical grade chitosan was washed with 1 L of distilled water three times to remove any residual iodine and/or iodide.

For the third treatment, 750 mL an iodinated filtrate according to Example 1 and the iodinated analytical grade chitosan from the second treatment were added to a 1 L glass bottle. The mixture was tumbled on Wheaton bench top roller at ambient temperature for 24 hr. The mixture was filtered to separate the iodinated filtrate and the iodinated analytical grade chitosan. The separated iodinated filtrate was evaluated for iodine and iodide. As shown in Table 1, the separated iodinated filtrate had a final iodine concentration of 60 ppm and no detectable iodide. Without wishing to be bound to any particular theory, it is believed that the iodine demand of the chitosan is high due to affinity of chitosan for iodine and/or the oxidation of residual organics associated with the chitosan and/or water.

TABLE 1

| | Analytical Grade | Industrial Grade |
|---|---|---|
| Initial iodine (I₂) | 294 ppm | 294 ppm |
| Initial iodide (I⁻) | ND | ND |
| First treatment final iodine (I₂) | ND | ND |
| First treatment final iodide (I⁻) | 139 ppm | 119 ppm |
| Second treatment final iodine (I₂) | ND | ND |
| Second treatment final iodide (I⁻) | 91 ppm | ND |
| Third treatment final iodine (I₂) | ND | ND |
| Third treatment final iodide (I⁻) | 60 ppm | ND |

The process was repeated for the industrial grade chitosan. As shown in Table 1, the separated iodinated filtrate after the first treatment had a final iodine concentration of 119 ppm, and no detectable iodine and iodide after the second and third treatments. Without wishing to be bound to any particular theory, it is believed that the lack of detectable iodide in the filtrate of the industrial grade chitosan indicates that the iodine demand by the chitosan is high, and the iodine demand for oxidizing residual organics associated with the chitosan and/or water is limited.

### Example 3

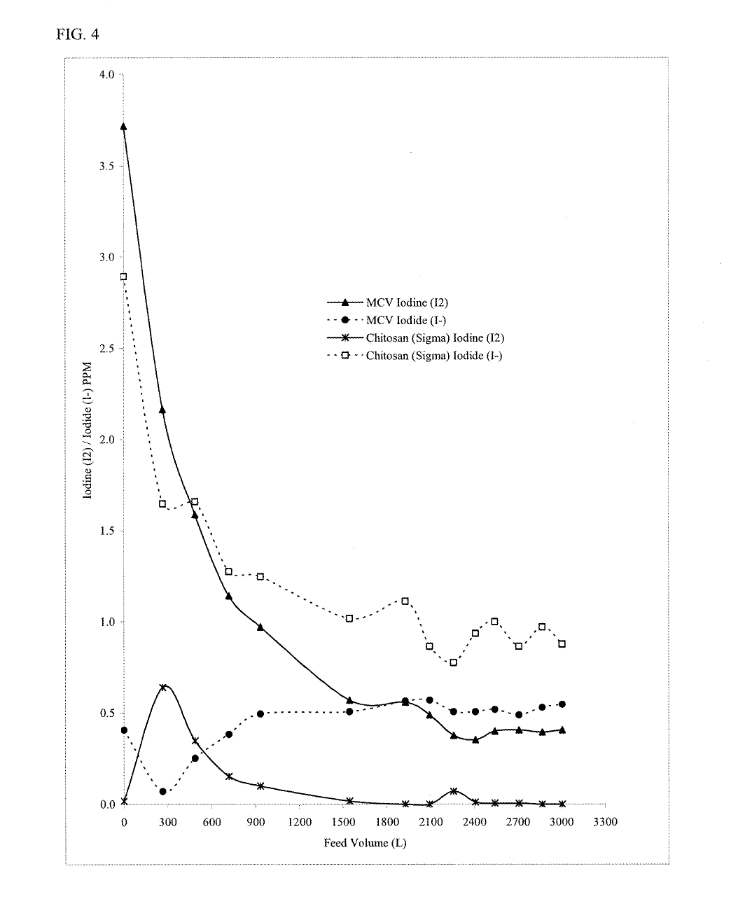

The results of an iodine (I₂)/iodide (I⁻) experiment of a water treatment system comprising MCV® Resin and untreated chitosan are shown in FIG. 4. The chitosan was analytical grade chitosan from [shrimp shells, ≧75% deacetylated] commercially available from Sigma. The volume of MCV® Resin was 10 cc, the mass of chitosan was 22 grams. The flow rate was 160 mL/min.

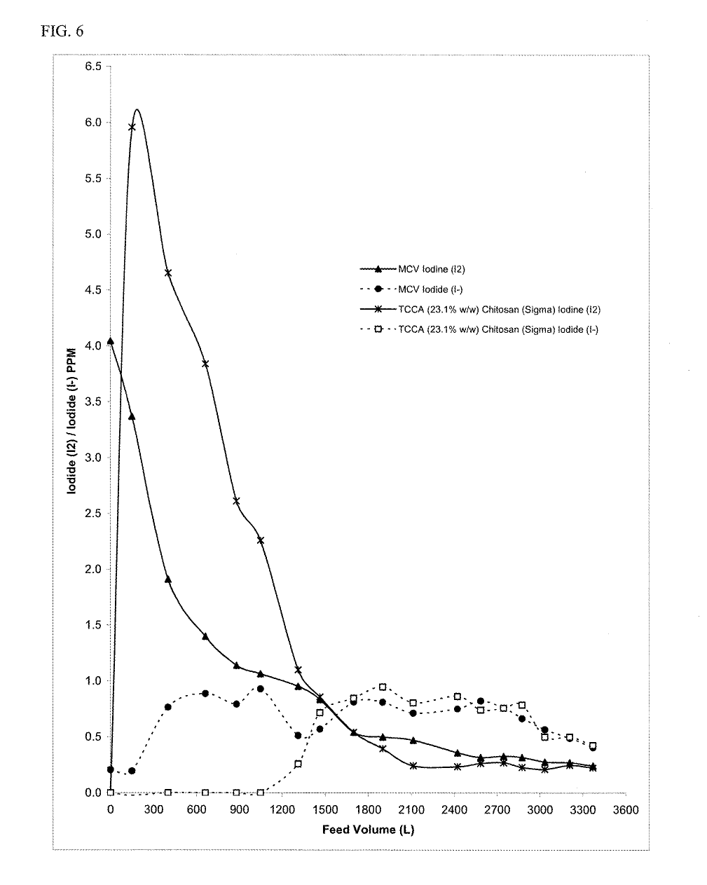

The results of an iodine (I₂)/iodide (I⁻) experiment of a water treatment system comprising MCV® Resin and chitosan treated with 23.1% (w/w) TCCA are shown in FIG. 6. The chitosan was analytical grade chitosan from [shrimp shells, ≧75% deacetylated] commercially available from Sigma. The TCCA was 6.6 g of analytical grade trichloroisocyanuric acid in water. The ratio of TCCA to chitosan was 1:3.33. The volume of MCV® Resin was 10 cc, the mass of chitosan was 22 grams. The flow rate was 160 mL/min.

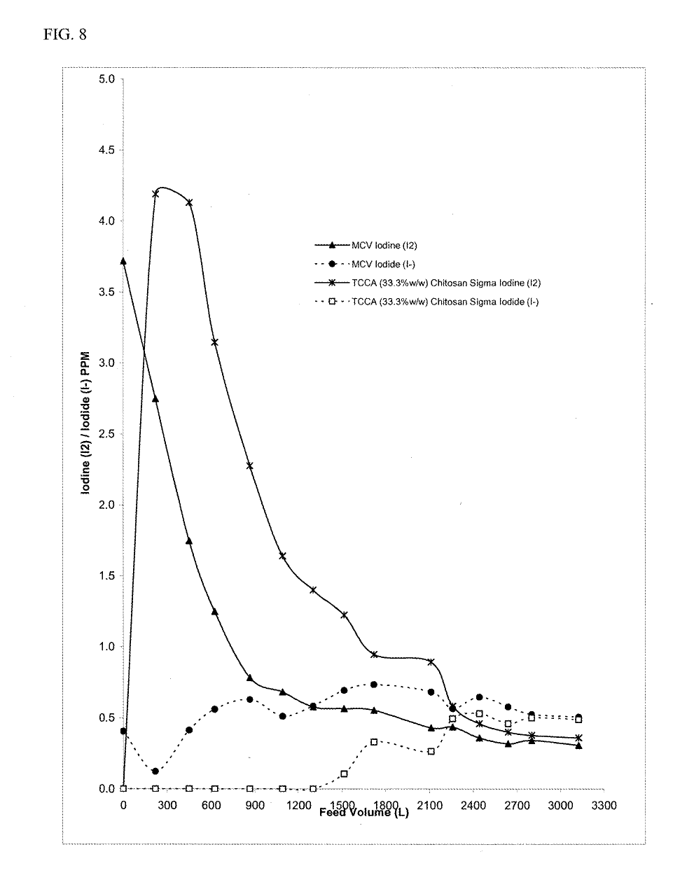

The results of an iodine (I₂)/iodide (I⁻) experiment of a water treatment system comprising MCV® Resin and chitosan treated with 33.3% (w/w) TCCA are shown in FIG. 8. The chitosan was analytical grade chitosan from [shrimp shells, ≧75% deacetylated] commercially available from Sigma. The TCCA was 11 g of analytical grade trichloroisocyanuric acid in water. The ratio of TCCA to chitosan was 1:2. The volume of MCV® Resin was 10 cc, the mass of chitosan was 22 grams. The flow rate was 160 mL/min.

### Example 4

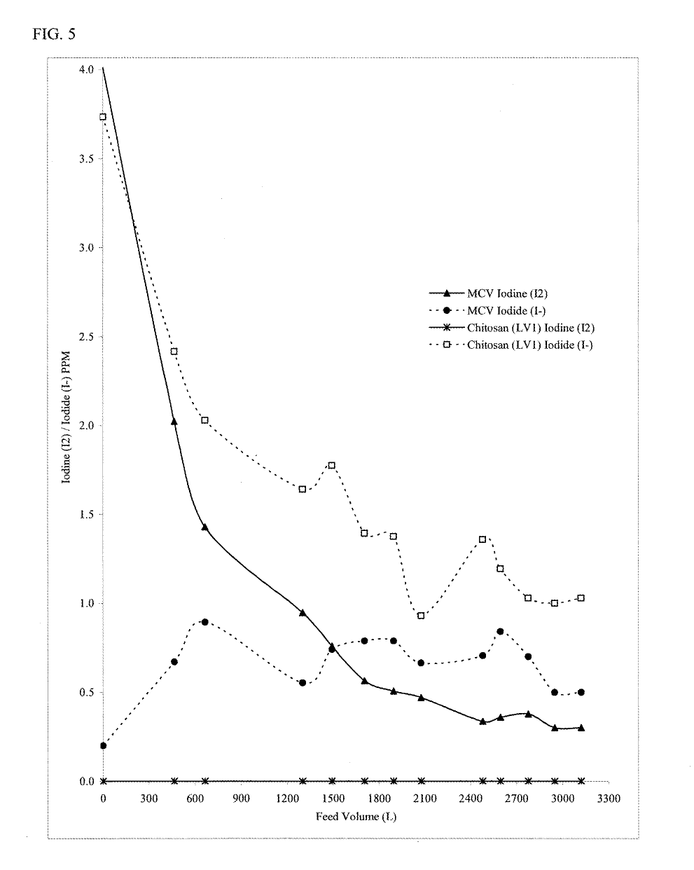

The results of an iodine (I₂)/iodide (I⁻) experiment of a water treatment system comprising MCV® Resin and untreated chitosan are shown in FIG. 5. The chitosan was industrial grade chitosan from [shrimp shells, ≧75% deacetylated] commercially available from LVI. The volume of MCV® Resin was 10 cc, the mass of chitosan was 22 grams. The flow rate was 160 mL/min

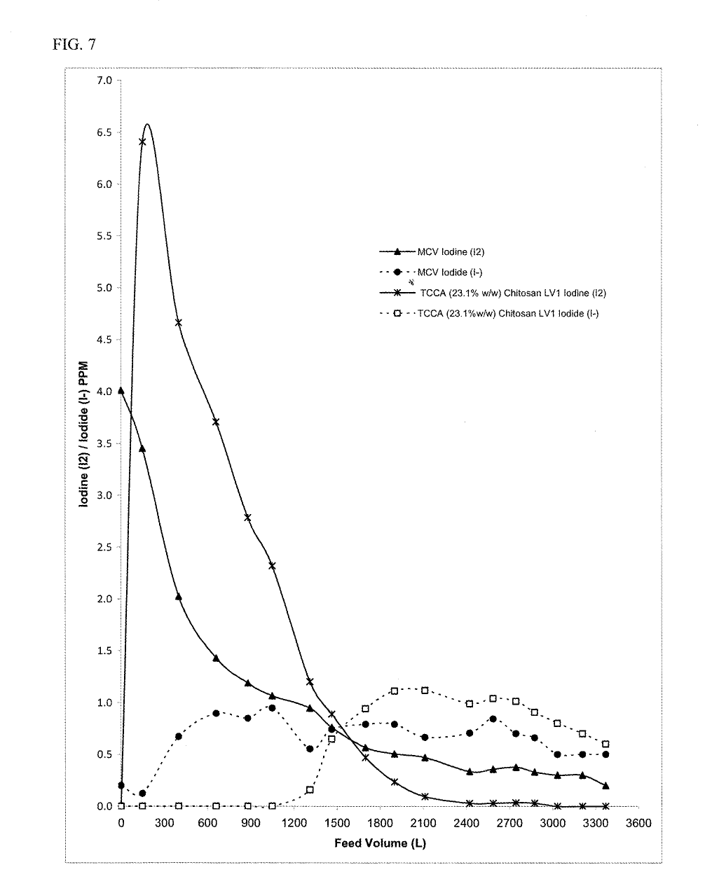

The results of an iodine (I₂)/iodide (I⁻) experiment of a water treatment system comprising MCV® Resin and chitosan treated with 23.1% (w/w) TCCA are shown in FIG. 7. The chitosan was industrial grade chitosan from [shrimp shells, ≧75% deacetylated] commercially available from LVI. The TCCA was 6.6 g of analytical grade trichloroisocyanuric acid in water. The ratio of TCCA to chitosan was 1:3.33. The volume of MCV® Resin was 10 cc, the mass of chitosan was 22 grams. The flow rate was 160 mL/min

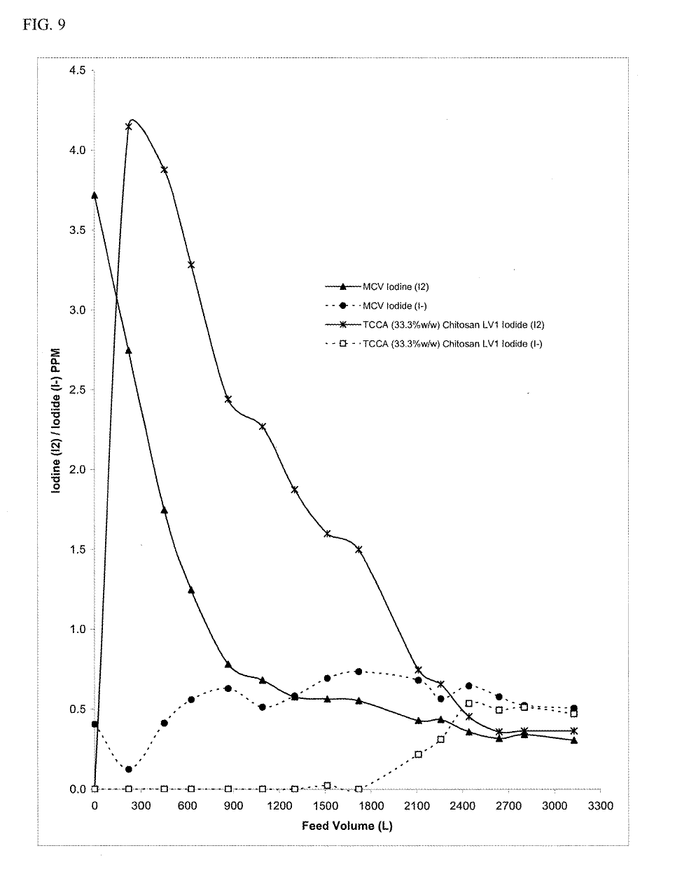

The results of an iodine (I₂)/iodide (I⁻) experiment of a water treatment system comprising MCV® Resin and chitosan treated with 33.3% (w/w) TCCA are shown in FIG. 9. The chitosan was industrial grade chitosan from [shrimp shells, ≧75% deacetylated] commercially available from LVI. The TCCA was 11 g of analytical grade trichloroisocyanuric acid in water. The ratio of TCCA to chitosan was 1:2. The volume of MCV® Resin was 10 cc, the mass of chitosan was 22 grams. The flow rate was 160 mL/min

### Example 5

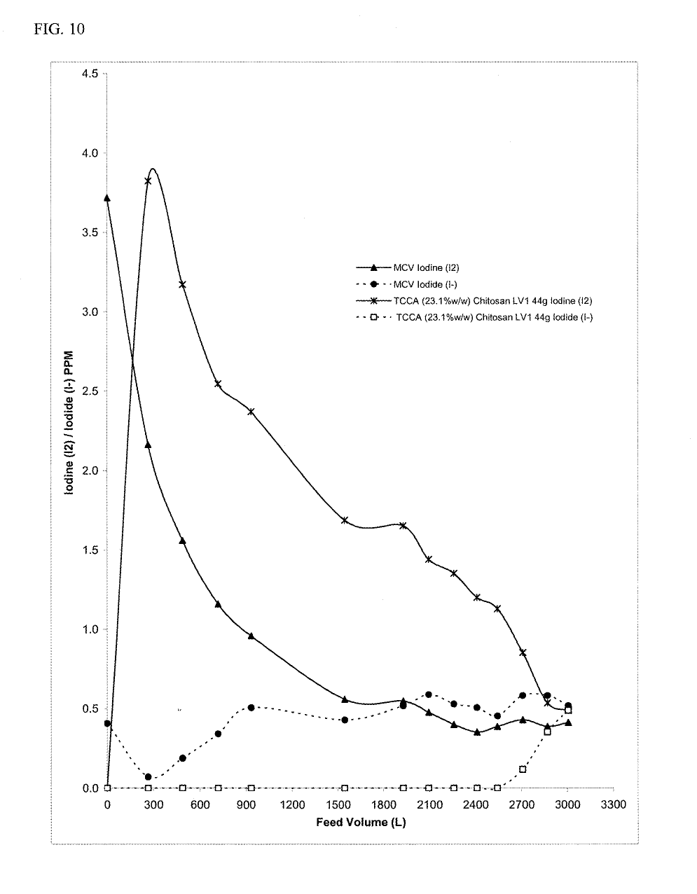

As shown in the FIG. 10, the water treatment system performed with very high halogen concentration until 2500 L. At 2500 L, the MCV Iodine was 0.4 ppm with 0.5 iodide leakage and the LVI Iodine was 1.1 ppm with no detectable iodide leakage. At this point a very high kill rate can be expected. After 2500 L, the LVI Iodine began to rapidly loose halogen concentration. The LVI Iodine achieved the same amount as MCV Iodine at about 2800-3000 L. At this point, the LVI Iodine and the MCV Iodine was the same. After 2700-2800 L, the extra performance by the LVI Iodine in terms of halogen concentration that was directly related with kill rate is reduced. The water treatment system may by more efficient and/or cost effective compared to conventional water treatment systems.

### Example 6

A challenge experiment was used to determine the ability of a water treatment system to reduce contaminants from a fluid. A challenge, or a known quantity of a selected microbiological contaminant, was added to the influent. The virus MS2 coliphage (ATCC 15597-B1) was chosen as the microbiological contaminant The amount of the contaminant in the influent and effluent was measured to determine the filtration capacity or microbial inactivation capacity of the water treatment system.

A challenge experiment of certain embodiments of the water treatment systems described herein was compared to other water treatment systems. A Log reduction value (Log PFU/mL) of 4 of MS2 in 3000 mL de-chlorinated tap water at room temperature was introduced to the water treatment system via the inlet and dispensed through the outlet. The influent and effluent were tested for MS2 coliphage before and after contact with the water treatment systems. The diameter of the MCV® Resin column was 2.5 cm and the diameter of the chitosan column was 4.2 cm.

The results of a challenge experiment of a water treatment system comprising MCV® Resin and analytical grade chitosan are shown in Table 2 and the results of a challenge experiment of a water treatment system comprising MCV® Resin and chlorinated analytical grade chitosan treated with 33.3% w/w TCCA are shown in Table 3. The volume of MCV® Resin was 10 cc, the mass of the chitosan was 22 grams, which had a volume of about 120 cc when hydrated. The feed volume was 3095 mL. The flow rate was 160 mL/min. The challenge was about 5 Log PFU/mL of MS2 in 3 L de-chlorinated tap water at room temperature. A control experiment of de-chlorinated tap water lacking MS2 showed no detectable plaques indicating there were no contaminations during the dis-infective assay.

TABLE 2

| | MS2 Population (Log PFU/mL) | | | |
|---|---|---|---|---|
| | | MS2 removal (Log PFU/mL) | | |
| | | Individual | | cumulative |
| Feed Volume | | MCV ® | | MCV ® Resin + |
| (mL) | Influent MS2 | Resin | Chitosan | chitosan |
| 0 | 5.48 | 3.08 | ≧2.40 | ≧5.48 |
| 465 | 5.04 | 1.96 | 1.38 | 3.34 |
| 896 | 5.23 | 1.08 | 0.97 | 2.05 |
| 1341 | 5.18 | 0.85 | 0.85 | 1.70 |
| 2091 | 5.41 | 0.63 | 1.01 | 1.64 |
| 3095 | 5.11 | 0.62 | 0.60 | 1.22 |

TABLE 3

| | MS2 Population (Log PFU/mL) | | | |
|---|---|---|---|---|
| | | MS2 removal (Log PFU/mL) | | |
| | | | | Cumulative |
| | | | | MCV ® |
| | | Individual | | Resin + |
| Feed Volume | | MCV ® | Chlorinated | chlorinated |
| (mL) | Influent MS2 | Resin | chitosan | chitosan |
| 0 | 5.48 | 3.08 | ≧2.40 | ≧5.48 |
| 465 | 5.04 | 1.96 | 3.08 | 5.04 |
| 896 | 5.23 | 1.08 | 2.30 | 3.39 |
| 1341 | 5.18 | 0.85 | 1.54 | 2.40 |
| 2091 | 5.41 | 0.63 | 1.18 | 1.81 |
| 3095 | 5.11 | 0.62 | 0.73 | 1.35 |

As shown in Table 4, without wishing to be bound to any particular theory, it is believed that the kill rate is directly correlated with the halogen concentration. At about 3000 L, there was no difference in performance probably due to TCCA treated chitosan almost completely out of attached chlorine in it.

TABLE 4

| | MS2 removal (Log PFU/mL) | | | |
|---|---|---|---|---|
| | | | MCV ® | |
| | | MCV ® | Resin + | |
| Feed Volume | MCV ® | Resin + | chlorinated | Difference in |
| (mL) | Resin | chitosan | chitosan | MS2 removal |
| 0 | 3.08 | ≧5.48 | ≧5.48 | +/0.00 |
| 465 | 1.96 | 3.34 | 5.04 | +1.70 |
| 896 | 1.08 | 2.05 | 3.39 | +1.34 |
| 1341 | 0.85 | 1.70 | 2.40 | +0.70 |
| 2091 | 0.63 | 1.64 | 1.81 | +0.17 |
| 3095 | 0.62 | 1.22 | 1.35 | +0.13 |

### Example 7

The results of a challenge experiment of a water treatment system comprising MCV® Resin and industrial grade chitosan are shown in Table 5 and the results of a challenge experiment of a water treatment system comprising MCV® Resin and chlorinated industrial grade chitosan treated with 33.3% w/w TCCA are shown in Table 6. The volume of MCV® Resin was 10 cc, the mass of the chitosan was 22 grams, which had a volume of about 180 cc when hydrated. The feed volume was 3095 mL. The flow rate was 160 mL/min. The challenge was about 5 Log PFU/mL of MS2 in 3 L de-chlorinated tap water at room temperature. A control experiment of de-chlorinated tap water lacking MS2 showed no detectable plaques indicating there were no contaminations during the dis-infective assay.

TABLE 5

| | MS2 Population (Log PFU/mL) | | | |
|---|---|---|---|---|
| | | MS2 removal (Log PFU/mL) | | |
| | | | | Cumulative |
| | | Individual | | MCV ® |
| Feed Volume | | MCV ® | Chitosan | Resin + |
| (mL) | Influent MS2 | Resin | (LVI) | Chitosan (LVI) |
| 0 | 5.48 | 3.08 | ≧2.40 | ≧5.48 |
| 465 | 5.04 | 1.43 | 1.91 | 3.34 |
| 896 | 5.23 | 1.15 | 1.35 | 2.50 |
| 1341 | 5.18 | 0.74 | 1.03 | 1.78 |
| 2091 | 5.41 | 0.71 | 0.93 | 1.64 |
| 3095 | 5.11 | 0.58 | 0.90 | 1.48 |

TABLE 6

| | MS2 Population (Log PFU/mL) | | | |
|---|---|---|---|---|
| | | MS2 removal (Log PFU/mL) | | |
| | | Individual | | Cumulative |
| | | | TCCA | MCV ® |
| | | | treated | Resin + |
| Feed Volume | | MCV ® | chitosan | TCCA treated |
| (L) | Influent MS2 | Resin | (LVI) | chitosan (LVI) |
| 0 | 5.48 | 3.08 | ≧2.40 | ≧5.48 |
| 465 | 5.04 | 1.43 | 3.61 | 5.04 |
| 896 | 5.23 | 1.15 | 2.08 | 3.23 |
| 1341 | 5.18 | 0.74 | 1.53 | 2.27 |
| 2091 | 5.41 | 0.71 | 1.63 | 2.34 |
| 3095 | 5.11 | 0.58 | 1.17 | 1.75 |

As shown in Table 7, the kill rate directly correlated with the halogen concentration. At about 3000 L, there was no difference in performance probably due to TCCA treated chitosan almost completely out of attached chlorine in it.

TABLE 7

| | MS2 removal (Log PFU/mL) | | | |
|---|---|---|---|---|
| | | | MCV ® | |
| | | MCV ® | Resin + | Difference |
| Feed Volume | MCV ® | Resin + | chlorinated | in MS2 |
| (mL) | Resin | chitosan | chitosan | removal |
| 0 | 3.08 | ≧5.48 | ≧5.48 | +/0.00 |
| 465 | 1.43 | 3.34 | 5.04 | +1.70 |
| 896 | 1.15 | 2.50 | 3.23 | +0.73 |
| 1341 | 0.74 | 1.78 | 2.27 | +0.49 |
| 2091 | 0.71 | 1.64 | 2.34 | +0.70 |
| 3095 | 0.58 | 1.48 | 1.75 | +0.27 |

### Example 8

The results of a challenge experiment of a water treatment system comprising MCV® Resin and chitosan treated with 23.1% (w/w) TCCA are shown in Table 8. The chitosan was industrial grade chitosan [from shrimp shells, ≧75% deacetylated] commercially available from LVI. The volume of MCV® Resin was 10 cc, the mass of chitosan was 44 grams, which had a volume of about 360 cc when hydrated. The feed water volume was 2900 L. The flow rate was 160 mL/min The challenge water was 3000 mL of about 5 Log PFU/mL of MS2 in de-chlorinated tap water at room temperature. A negative control was performed with de-chlorinated tap water without MS2 that showed no detectable plaques indicating there were no contaminations during the dis-infective assay.

TABLE 8

| | MS2 Population (Log PFU/mL) | | | |
|---|---|---|---|---|
| Feed Volume (mL) | | | Log removal | |
| 2900 | Influent | Effluent | Individual | Cumulative |
| MCV ® Resin | 5.2 | 4.7 | 0.5 | 0.5 |
| Halogenated | 4.7 | 3.1 | 1.6 | 2.1 |
| Chitosan | | | | |

As shown in Table 8, the water treatment system removed about 2.1 Log PFU/mL MS2 near the end of its capacity (3000 L). At the chitosan effluent there was dramatic reduction of halogen concentration after 2500 L aging.

All documents cited herein are incorporated herein by reference, but only to the extent that the incorporated material does not conflict with existing definitions, statements, or other documents set forth herein. To the extent that any meaning or definition of a term in this document conflicts with any meaning or definition of the same term in a document incorporated by reference, the meaning or definition assigned to that term in this document shall govern. The citation of any document is not to be construed as an admission that it is prior art with respect to this application.

While particular embodiments of water treatment systems have been illustrated and described, it would be obvious to those skilled in the art that various other changes and modifications can be made without departing from the spirit and scope of the invention. Those skilled in the art will recognize, or be able to ascertain using no more than routine experimentation, numerous equivalents to the specific apparatuses and methods described herein, including alternatives, variants, additions, deletions, modifications and substitutions. This application including the appended claims is therefore intended to cover all such changes and modifications that are within the scope of this application.

What is claimed is:

1. A water treatment system comprising multiple halogens to provide potable water, the system initially comprising:
an inlet in fluid communication with an outlet;
a halogen release system comprising a first halogen having a first oxidizing potential, wherein the halogen release system is intermediate the inlet and the outlet; and
a halogenated chitosan comprising a second halogen having a second oxidizing potential, wherein the halogenated chitosan is intermediate the halogen release system and the outlet,
wherein the second oxidizing potential is greater than the first oxidizing potential.

2. The system of claim 1, wherein the halogen release system is selected from the group consisting of chlorinated resins, iodinated resins, brominated resins, and combinations thereof.

3. The system of claim 1, wherein the halogenated chitosan is selected from the group consisting of chlorinated chitosan, brominated chitosan, iodinated chitosan, and combinations thereof.

4. The system of claim 1, wherein the halogenated chitosan is a pristine chlorinated chitosan free from iodine and iodide.

5. The system of claim 1, wherein the first halogen is iodine and the second halogen is chlorine.

6. The system of claim 1 comprising a chlorinating agent, wherein the chlorinating agent is trichloroisocyanuric acid.

7. The system of claim 1 comprising a scavenger barrier intermediate the halogenated chitosan and the outlet.

8. The system of claim 7, wherein the scavenger barrier comprises at least one of carbon and an anion exchange resin.

9. The system of claim 7, wherein the halogen release system comprises an iodinated resin, the halogenated chitosan comprises a chlorinated chitosan, and the scavenger barrier comprises an anion exchange resin.

10. The system of claim 7, wherein the halogen release system comprises an iodinated resin, the halogenated chitosan comprises a chlorinated chitosan, and the scavenger barrier comprises an anion exchange resin and granular activated carbon.

11. The system of claim 7 comprising a ratio of the halogen release system to the halogenated chitosan, by volume, from 1:18 to 1:36, and a ratio of the halogen release system to the scavenger barrier, by volume, of 1:5.

12. A method of treating water comprising at least one contaminant by the system of claim 5, the method comprising flowing the water sequentially through the inlet, the halogen release system, the halogenated chitosan and the outlet to provide potable water, wherein the system has a Log reduction value for viruses of at least 4 and a Log reduction value for bacteria of at least 6.

13. The method of claim 12, wherein the second halogen oxidizes the first halogen.

14. The method of claim 12, wherein the water flowing from the outlet is free of chlorine, iodine, and iodide.

15. A method of manufacturing a water treatment system initially comprising multiple halogens comprising an inlet in fluid communication with an outlet, a halogen release system intermediate the inlet and the outlet, and a halogenated chitosan intermediate the halogen release system and the outlet, the method comprising:
contacting a halogenating agent and a filter material comprising chitosan or a derivative thereof to generate the halogenated chitosan;
positioning the halogen release system intermediate the inlet and the outlet; and
positioning the halogenated chitosan intermediate the halogen release system and the outlet.

16. The method of claim 15, wherein the halogenating agent comprises one of an aqueous iodine mixture and an aqueous trichloroisocyanuric acid mixture.
